(19) United States
(12) Patent Application Publication
(10) Pub. No.: US 2015/0347926 A1
(43) Pub. Date: Dec. 3, 2015

(54) Fast Naive Bayesian Framework with Active-Feature Ordering

(71) Applicant: salesforce.com, inc., San Francisco, CA (US)

(72) Inventor: Matthew Fuchs, Los Gatos, CA (US)

(73) Assignee: salesforce.com, inc., San Francisco, CA (US)

(21) Appl. No.: 14/690,127

(22) Filed: Apr. 17, 2015

Related U.S. Application Data
(60) Provisional application No. 62/006,800, filed on Jun. 2, 2014.

(51) Int. Cl. G06N 99/00; G06N 7/00

(52) U.S. Cl. CPC G06N 99/005; G06N 7/005

(57) ABSTRACT

The technology described uses a Naïve Bayes Classifier with Active-Feature Ordering to identify contributors to a contact database who are likely to be able to update an arbitrary contact. The technology disclosed further relates to identifying the n most likely records with a number of features, with each feature having a specific finite number of different possible values. The disclosed technology also describes using a Naïve Bayes Classifier with Active-Feature Ordering for diagnostic screening, to evaluate a patient's symptoms against a compendium of diseases to choose the diseases with the greatest posterior likelihood given the vector of observed symptoms of the patient. The disclosed technology additionally describes using a Naïve Bayes Classifier with Active-Feature Ordering for crowd sourcing tasks, using a sample data set that includes thousands of workers, to identify a worker, who is experienced, to complete a featured task.

### RELATED APPLICATION

This application is related to and claims the benefit of U.S. Provisional Patent Application 62/006,800, entitled, “Fast Naïve Bayesian Framework with Active-Feature Ordering” filed on Jun. 2, 2014 (Attorney Docket No. SALE 1076-1). This application is also related to U.S. Provisional Patent Application No. 61/970,295, entitled, “A Naive Bayesian Framework for Contributor Recommendations” filed on Mar. 25, 2014, (Attorney Docket No. SALE 1074-1). These two provisional applications are hereby incorporated by reference for all purposes.

### FIELD OF DISCLOSURE

The technology described uses a Naive Bayes Classifier (NBC) with Active-Feature Ordering to evaluate an object against all classes to choose the class with the greatest posterior likelihood. This approach is unusual in two ways.

The inventor is not aware of other attempts to use Naive Bayes Classifier (NBC) with Active-Feature Ordering as a recommendation engine. Generally NBC is used to classify its input into a small number of classes—far too small for a recommendation system.

We are building out a Naive Bayes Classifier (NBC) with so-called Active-Feature Ordering using a sample data set that has tens of thousands of (if not over 100K) classes. NBCs normally have a small fraction of that many classes.

The technology described can be used in a number of recommendation settings and is not limited to the example setting of contact information for prospects or customers. We include a diagnostic screening use case with a sample data set that includes thousands of disease classes; and a crowd sourcing task use case that uses a sample data set that includes thousands of workers.

### BRIEF DESCRIPTION OF THE DRAWINGS

FIG. 1 illustrates one implementation of a Naive Bayes Classifier (NBC) with Active-Feature Ordering environment.

FIG. 2 shows example block diagrams for components of a Naïve Bayes Classifier (NBC) with Active-Feature Ordering.

FIG. 3 illustrates one implementation of training a Naive Bayes Classifier (NBC) with Active-Feature Ordering.

FIG. 4 illustrates one implementation of applying a Naive Bayes Classifier (NBC) with Active-Feature Ordering.

FIG. 5A illustrates example numbers for a training set for an NBC with Active-Feature Ordering.

FIG. 5B illustrates a training set for an NBC with Active-Feature Ordering with example numbers.

FIG. 6 is a block diagram of an example computer system.

### DETAILED DESCRIPTION

The following example of applying the technology disclosed is given in the context of contact information for prospects or customers. This kind of information is used in a sales environment and generally in business. Not to be limited by the example, the technology disclosed can adapt NBC to recommendation engines with thousands, tens of thousands or more classes.

Contacts are “grave yarded” due to bad or outdated information. These contacts could be saved, if one were to get corrected information. But who would have that information? Crowd sourcing systems have many contributors of contacts, but it's not obvious how to pick out a contributor likely to know about a contact, who can update the outdated contact information. The original contributor could be a good choice, but they may not be available or reliable.

From a machine learning perspective, we could attempt to model the problem by determining a set of features likely to be relevant to the problem, presenting contacts to contributors to see which are successful in updating information, and then using a variety of techniques to determine which of our features are actually predictive. This sketch of a solution is almost intractable, as few contributors will be able to aid us for any given contact. We would be likely to ask a prohibitive number of users for help to get any decent amount of usable feedback.

Assuming, however, that there must be some relationship between the contacts a user contributes or updates and the larger set of contacts the user would be able to provide information on, we can look at the set of user actions as a kind of training set, suggesting an initial framework which we can expect to be the best we can do without a training set of actual examples of users being presented with contacts to update. In addition, because we have no a priori knowledge of how features may interact in general or for a specific user, we can make the simplifying assumption that they are independent.

Given all of this, naive Bayes classifiers (NBC) become an interesting technology for implementing a recommender system for this problem, using the thousands of contributors as the different classes. Once one makes the independence assumption—and we don't have the data to do otherwise—NBC is an excellent choice, especially given that we don't know what the dependencies, if any, are; most of our data is discrete; and we don't know which features are most significant. In the absence of any of this information, the NBC training algorithm deals with class size, feature values and distribution. In essence, it's the best we can do without knowing anything.

As input to the classifier we have entries containing several generic contact features—company, rank, domain, department, location data, etc. It is useful to include features that are sufficiently general. Using a cell phone number as a feature, for instance, would mean that very few contacts would have a high probability match other than the original contributor. The class for each entry is a contributor who either contributed the contact or updated it. This means that each contact may appear more than once.

NBC has been applied to a dataset for this problem of about 7.5 million records with over 41K classes. Testing on a training set of about 1.9 MM records, most of the records matched strongly (>0.99) with just one class or user—usually the contributor. In other cases, the probabilities were more spread around, but the group of likely users remained small.

One training set for Naive Bayes Classifier (NBC) with the described Active-Feature Ordering would be records with a number of features 442, with each feature having a finite number of different possible values 444. Each record has values for features. For each class/feature/value combination, we know that there is a specific number of times in the training set that the value appeared for that feature in a training instance classified as belonging to that class.

To evaluate the likelihood that a record belongs to a specific class, we consider each feature in the record, determining the likelihood of that value for that feature for that class (divide the size of the class/feature/value combination by the size of the class), multiplying them together, and then multiplying that result by the class prior (number of training instances of that class divided by the total number of training instances). This can be expressed as count or probabilities:

As estimated from a training set, the likelihood that a record belongs to class cⱼ is

$$P ( {c}_{j} ) \times {\prod }_{i} P ( ( {f}_{i} , {v}_{i} ) \vert {c}_{j} )$$

$$or$$

$${\prod }_{i} \frac{Cnt ( {f}_{i} , {v}_{i} ) \vert {c}_{j}}{Cnt ( {c}_{j} )} \times \frac{Cnt ( {c}_{j} )}{{Σ}_{m} Cnt ( {c}_{m} )}$$

Of these equations, the first equation is in terms of counts, the second in terms of likelihoods. The first part, P(cⱼ), is the prior likelihood of class cⱼ, the likelihood that something is of that class without considering the features. We calculate that likelihood (in the first equation) by taking the number of instances we've seen of the class (numerator) and dividing that by the total number of instances we are using (the sum in the denominator over all classes). We then multiply that by the likelihoods of the various features, given the class; i.e. if we're actually looking at class cⱼ, what is the likelihood that feature fᵢ will have value vᵢ, which we get (upper equation) by counting how many of the cⱼ instances have value vᵢ for feature fᵢ. This gives us the likelihood that the record is of class cⱼ. To pick the class to which we think the record belongs, we pick the class with the highest likelihood.

If our goal is to determine relative likelihood among the classes, then this is enough. If we want absolute likelihoods, then we are required to complete this process for all classes and then normalize them by adding all the values and using the sum as the denominator. Further, if we want the n most likely classes, then at any point we'll have n candidates and we need to do as many multiplications as necessary, to determine if some other class is more or less likely than our n candidates.

Given tens of thousands of classes 414, there is little point in determining likelihoods for all classes for any record we are trying to classify. There are unlikely to be more than a few classes that even have combinations of feature values that intersect with the record. Instead, we will want the top n classes for some small value of n, like 5, 10, 15, 20 or in a range of 5 to 50. We need do enough work to find those classes that have combinations of feature values that intersect with the record. In particular, there is no need to evaluate the many thousand classes with no overlap with the record to classify. So our goal is to minimize the work we need to do.

Our approach is to order the k features from 0 to k−1 on decreasing number of feature values (i.e., feature 0 has more possible values than feature 1). Within each feature we have the possible values 444, and for each value we order the classes in a priority queue by decreasing likelihood. We then incrementally evaluate high likelihood classes from left to right 418. We order them this way because, with smoothing, the number of feature values is in the denominator of P(f|C); therefore there is a strong penalty to any class not having any training examples with the appropriate feature value. (Smoothing is a technique that treats each class as having at least one training example for each feature value so the probability of a class doesn't go to zero because there was not a training example with each possible feature.) In some implementations, it may be desirable to reject classes that do not have any training examples for a particular feature-value. Classes which match a value for such a feature are more likely to have “local expertise” since they represent smaller sets.

We have a record represented by a list of feature values sorted according to the order given above. We also have a queue, the current set, of classes under consideration and their likelihoods, with a current minimum value, initially 0, and size. We can initialize this set using the n most likely classes and the likelihoods they'd have if none of the features from the record occur for that class, or some constant value that represents a minimum or floor value for the top n classes.

Given the list of feature values, we can retrieve a queue of classes 446 for each value, so we now have those ordered from 0 to k−1. Additionally we have a table, seen classes, initially empty, of all the classes we have seen, the last feature we saw them for, and what the estimated probability at that point was.

We describe a method of evaluating the records, feature by feature, from left to right 418.

First, we determine the maximum coefficient of any new class, by multiplying the likelihoods of the most likely classes (top of the queue) for all the features we are not currently considering. This is approximately constant for the feature.

Next, we reevaluate our current set for the current feature. We take each class from the current set and multiply its current likelihood against its likelihood for the current feature; the result being another priority queue. As we go through records, we remove them from the current feature queue if they appear there. We then find the current likelihood of the nth most likely class.

We then go through the classes for the current feature/value, in descending order. For example, consider the process of examining feature j and the top class is class c:
If we have not seen the class before, before doing anything more, we take its likelihood for j, and multiply it by the maximum coefficient. This value is higher than the highest possible likelihood that c or any remaining class in the queue could have.
   If the product is lower than the current minimum, then we are done with the feature. We add it to the seen classes table with the last feature seen as 0 and the value as the class prior.
   Otherwise we start evaluating c for features 0 through j by successively multiplying the class prior by the individual feature likelihoods.
      If this value ever drops below the current minimum then we store this class in the seen classes table with the current value and the last feature evaluated.
      Otherwise the result is larger than the current minimum and we add this to the current set as well as the seen classes table.
If we have seen the class before, then we retrieve it from the seen classes table.
We then evaluate it for features, starting from the last feature for which it was seen and continuing through j. If the value drops below the current minimum we store the new value in the seen classes table.
   If the resulting value is greater than the current minimum, we insert it in the current set and update the seen classes table. Every time we evaluate a class for a given feature, we remove that value from the priority list for that feature, and we track the minimum value for each of the features.

As we complete the process from feature 0 to feature k, we obtain a set of candidates which is generally extremely close to the correct values. Then, to catch a few classes that can slip through the cracks, we complete two steps:
Evaluate the values in the seen classes table, stopping if the likelihood falls below the current minimum.
We describe the second step we use to catch other values which may have been missed. Class likelihoods may be large for some features and small for others.
The value above misses class likelihoods which are not large enough to show up at the top, but which overall are greater than others. Therefore we make another pass through the features, stopping whenever:
   the likelihood for a feature is less than the minimum value seen in the first pass; or
   the likelihood for a class is less than the current minimum

This completes the process of identifying the desired set. The top n values are the desired set of classes.

Some implementations of this technology run much faster than the NBC algorithms known in the art. For example, an early NBC approach by this team to recommendations ended up with 17 features and over 40K classes. This led to an evaluation time of about 350 milliseconds per record, or just over ⅓ second, using the standard algorithm.

Applying the method described above handles the same dataset in about 9.3 milliseconds, or an almost 38× speedup. Given a larger database of 40 MM records, given these speeds, even on a 12-core server, the naive algorithm would take about 324 hours to complete vs. about 9 hours when applying the technology described here.

While the technology disclosed is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

Naïve Bayes Classifier Environment

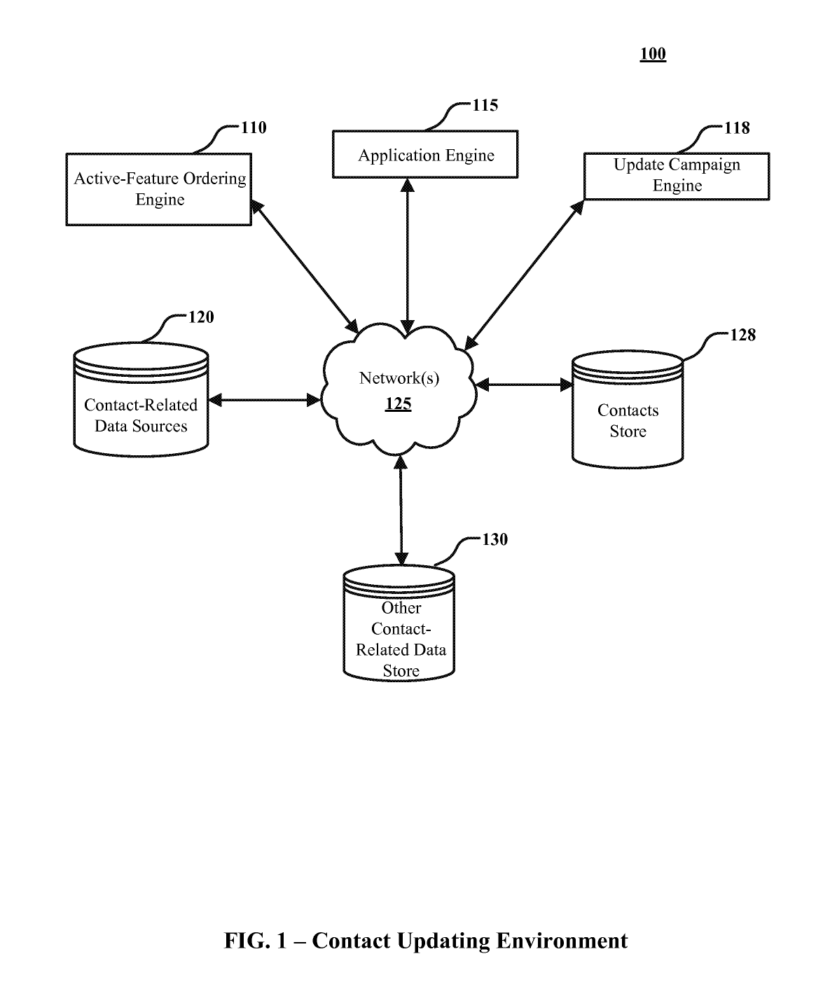

FIG. 1 illustrates one implementation of a Naive Bayes Classifier (NBC) with Active-Feature Ordering environment 100. FIG. 1 also shows that environment 100 can include contact-related data sources 120, other contact-related data store 130 and contacts store 128. The social data store 145 can hold social accounts 140 and social handles 146. FIG. 1 also illustrates a Naive Bayes Classifier (NBC) with active-feature ordering engine 110, application engine 115 and update campaign engine 118. In other implementations, environment 100 may not have the same elements as those listed above and/or may have other/different elements instead of, or in addition to, those listed above.

The contacts store 128 can hold business-to-business contacts such as accounts, contacts and leads along with supplemental information. In some implementations, this supplemental information can be names, addresses, number of employees and other contact-related information.

The Naive Bayes Classifier (NBC) with active-feature ordering engine 110 can match attributes of contacts with users during training In some implementations, the Naive Bayes Classifier (NBC) with active-feature ordering engine 110 can calculate the most likely n records by applying Naïve Bayes training The results can be output and persisted on data storage. In this application, data storage expressly excludes waves. It includes RAM, rotating memory and solid state memory. It can output the results to data storage either persistently or being used by another engine.

The application engine 115 can apply the results calculated by the Naive Bayes Classifier (NBC) with active-feature ordering engine 110 to broken contact records that are in need of updating due to one or more attributes or fields that contain faulty data. Identified pairs of broken contact records and users can be output and persisted on data storage.

The update campaign engine 118 can conduct a campaign to obtain updates, and/or edits to the broken contact records. The nature of the campaign is beyond the scope of this disclosure.

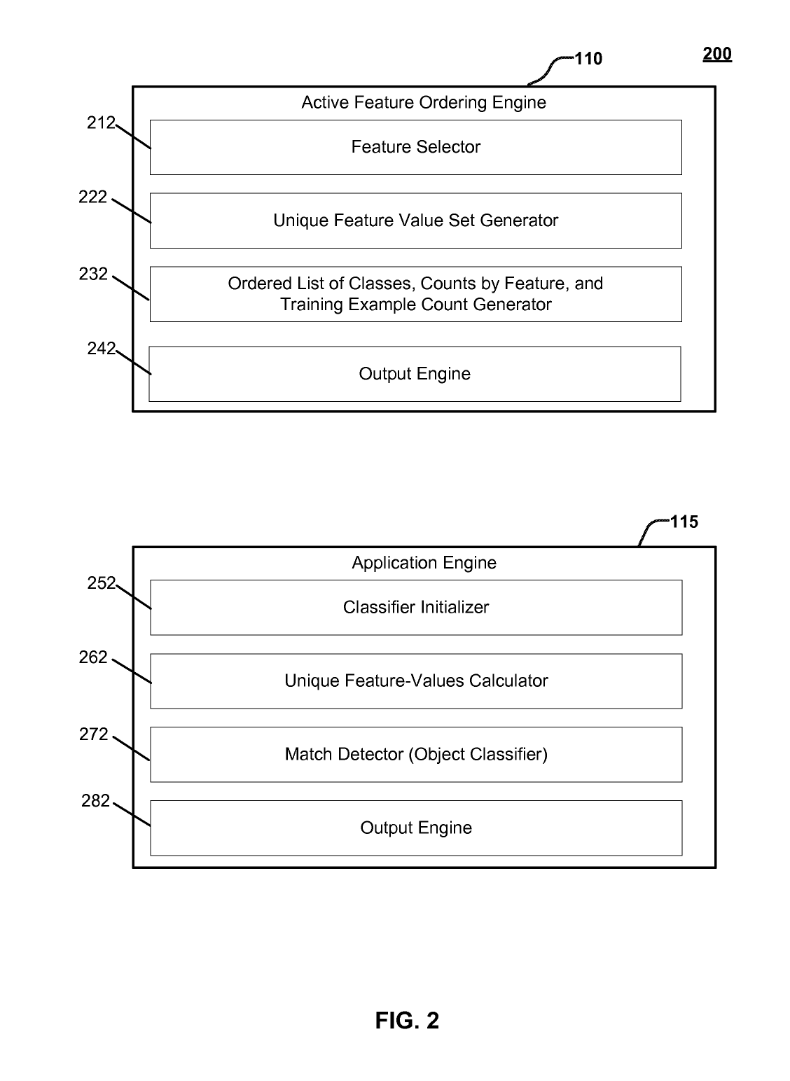

FIG. 2 illustrates functional blocks of active-feature ordering engine 110. Feature selector 212 selects features of a training set to use for top-n classes classification. Unique feature-value set generator 222 generates from training examples in the training set, a set of unique feature-values for each of the features. Ordered list of classes, counts by feature, and training example count generator 232 generates, from the training set, an ordered list of classes and counts by class of the training examples that include the unique feature-values. Generator 232 also generates counts by feature of the unique feature-values, and a count of the training examples in the training set. Output engine 242 outputs the generated set, ordered list and counts to use in a top-n classes classifier.

FIG. 2 also illustrates functional blocks of application engine 115. Classifier initializer 252 initializes a top-n-classes classifier with a configuration data set that includes sets of unique feature-values, ordered lists of classes that include the unique feature-values, and counts of the training examples that include both the unique feature-values and the classes. Training set results from output engine 242 form the configuration data set. Unique feature-values calculator 262 loads or calculates counts by feature of the unique feature-values and a count of training set elements that are available from output engine 242. Match detector (object classifier) 272 classifies a target object into a predetermined number of classes, using selected features in the configuration data set, beginning with a first feature that has more feature-values than other features; and evaluates at least relative likelihood of the first feature-value belonging to at least the predetermined number of classes in the ordered list of classes for the first feature-value, for a first feature-value of the first feature of the target object. Match detector (object classifier) 272 processes the additional features in order of decreasing number of unique feature-values per feature, updating the relative likelihoods for feature combinations of the target object that include the additional features using the ordered lists of classes. Output engine 282 delivers the predetermined number of classes for the target object based on the updated relative likelihoods.

### Training a Classification Framework

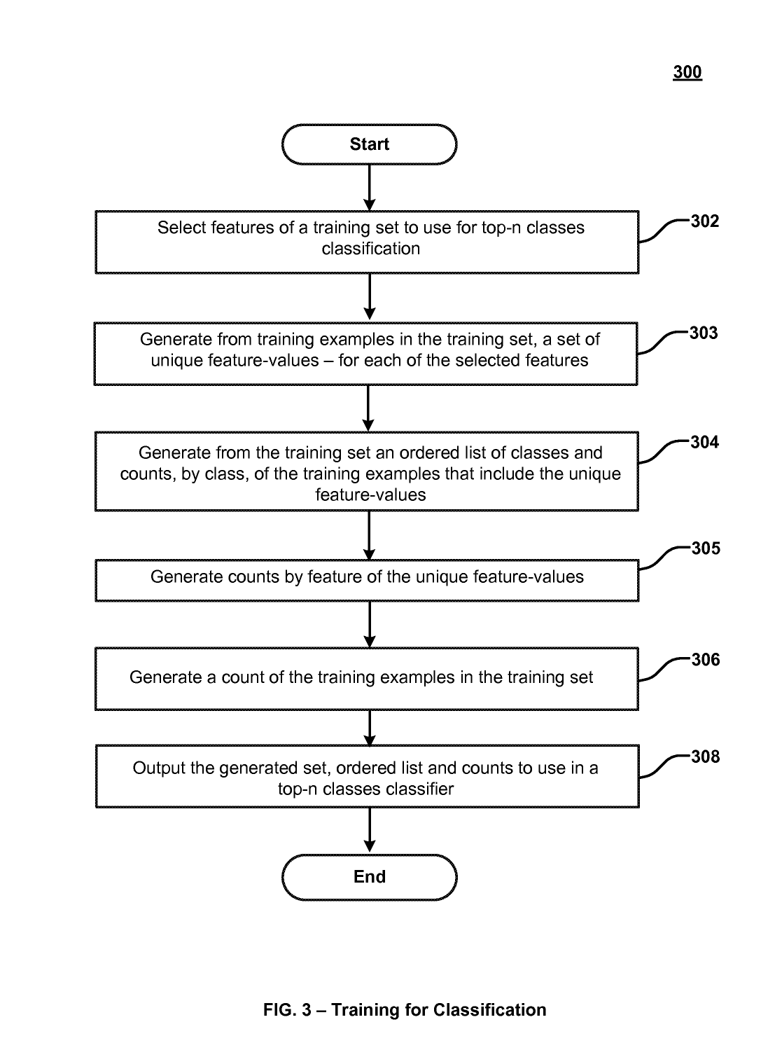

FIG. 3 shows the flow 300 of one implementation of training a Naive Bayes Classifier (NBC) with Active-Feature Ordering. Other implementations may perform the steps in different orders and/or with different, fewer or additional steps than the ones illustrated in FIG. 3. Multiple steps can be combined in some implementations. For convenience, this flowchart is described with reference to the system that carries out a method. The system is not necessarily part of the method.

At step 302, the active-feature ordering engine can select features of a training set to use for top-n classes classification.

At step 303, the active-feature ordering engine can generate from training examples in the training set, a set of unique feature-values for each of the features.

At step 304, the active-feature ordering engine can generate, from the training set, an ordered list of classes and counts by class of the training examples that include the unique feature-values.

At step 305, the active-feature ordering engine can generate counts by feature of the unique feature-values.

At step 306, the active-feature ordering engine can generate a count of the training examples in the training set.

At step 308, active-feature ordering engine can output the generated set, ordered list and counts to use in a top-n classes classifier.

### Applying Training Results in a Fast Bayesian Framework

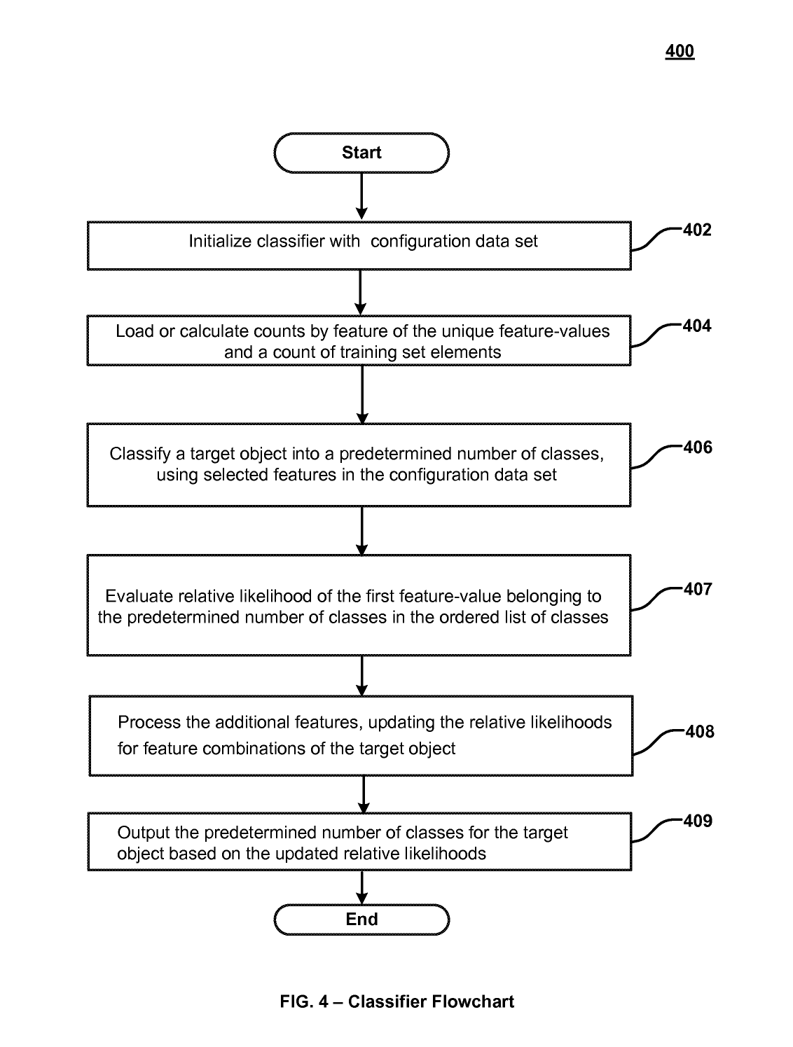

FIG. 4 shows a flow 400 of one implementation of applying a Naive Bayes

Classifier (NBC) with active-feature ordering. Other implementations may perform the steps in different orders and/or with different, fewer or additional steps than the ones illustrated in FIG. 4. Multiple steps can be combined in some implementations. For convenience, this flowchart is described with reference to the system that carries out a method. The system is not necessarily part of the method.

At step 402, an application engine can initialize a top-n-classes classifier with a configuration data set that includes sets of unique feature-values, ordered lists of classes that include the unique feature-values, and counts of the training examples that include both the unique feature-values and the classes.

At step 404, the application engine can load or calculate counts by feature of the unique feature-values and a count of training set elements.

At step 406, the application engine can classify a target object into a predetermined number of classes, using selected features in the configuration data set, beginning with a first feature that has more feature-values than other features.

At step 407, the application engine can evaluate at least relative likelihood of the first feature-value belonging to at least the predetermined number of classes in the ordered list of classes for the first feature-value, for a first feature-value of the first feature of the target object.

At step 408, the application engine can process the additional features in order of decreasing number of unique feature-values per feature, updating the relative likelihoods for feature combinations of the target object that include the additional features using the ordered lists of classes.

At step 409, the application engine can output the predetermined number of classes for the target object based on the updated relative likelihoods.

### Training Set Example

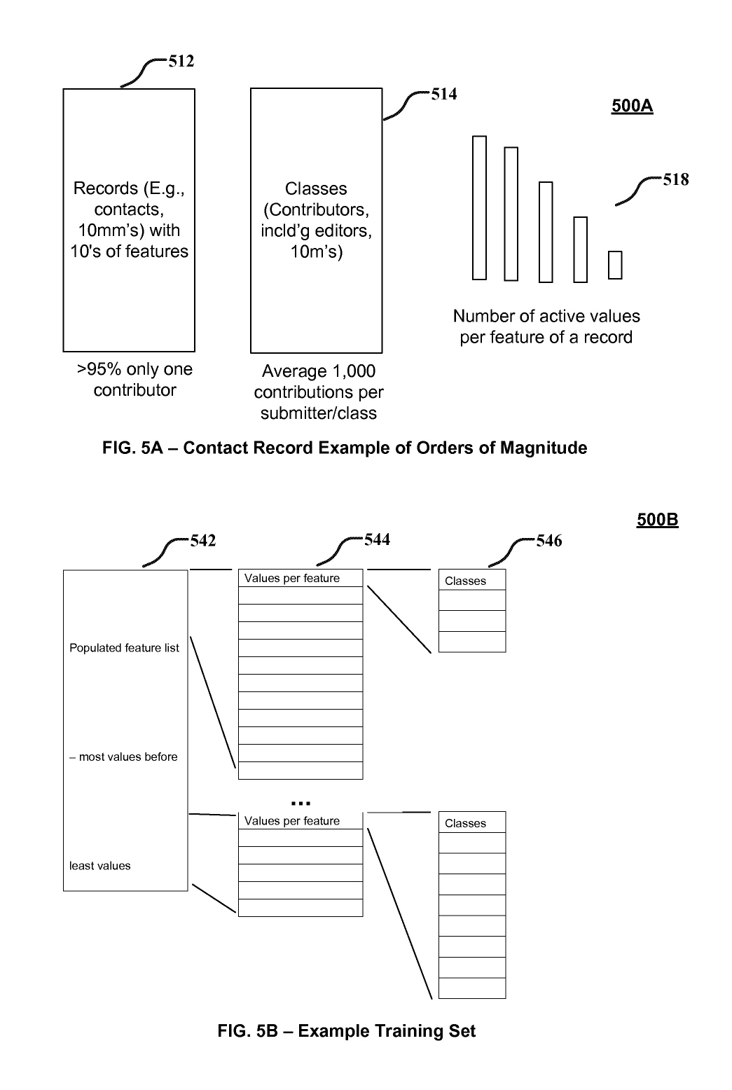

FIG. 5A illustrates an example of order of magnitude values for records, classes, contributions and contributors for a contact information training set. Tens of millions of contact records 512 share 10s of features. More than 95% of the contacts are contributed or edited by a single contributor. There are tens of thousands of classes representing contributors—submitters and editors—that submit 1,000s of contacts 514, on average. Data in training set records has features, attributes or fields. These orders of magnitude are offered for purposes of understanding an example, not as limitations on the disclosure.

The features of objects in the training set have counts of unique feature-values, which are possible values of a particular feature that have training examples. The features can be generally ordered in descending order of the number of active values per feature 518, features with more active values to be processed before features with fewer active feature-values (subject to banding and other minor variations from the descending order.)

FIG. 5B illustrates an example of a contact information training set. Data can be represented by a populated feature list 542 with the features with the most active feature-values 544 listed before those with fewer active feature values. The more feature-values 544 for a particular feature, the fewer classes 546 for an average feature-value combination, because the same training examples are used for all features.

Additional use cases include disease diagnosis and crowd sourcing, which are described below.

### Diagnostic Screening Use Case

Machine learning has also been applied to disease diagnosis, a problem which has an ongoing challenge of having a wealth of data within the healthcare system, and computationally intensive and time-consuming analysis methods. The disclosed technology offers systems and methods for evaluating more diseases using less time.

An interesting question in the context of predictive medical diagnosis is, “how many times do people with this disease have these symptoms?” We recognize that people who have a particular disease have specific symptoms; and we have a list of diseases that exhibit particular symptoms. For example, we may be trying to diagnose malaria in a region infested with malaria-carrying mosquitos. Some noise may be injected into the analysis by the presence of symptoms, such as congestion caused by spring allergies that are unrelated to a patient's disease.

If we assume independence between diseases, Naive Bayes classifier (NBC) becomes an interesting technology for implementing a diagnosis predictor system for this problem. We can apply naive Bayes classifier (NBC) with active-feature ordering as a diagnosis classifier, evaluating a patient's condition against possible diagnoses, given the observed symptoms of the patient.

The training set for a diagnosis classifier can include a very extensive set of potential disease diagnoses, which can be represented as classes. As an example of the number of classes in the disease data set, the World Health Organization estimates that over 10,000 human diseases are known to be caused by a single error in a single gene in the human DNA. The extensive number of disease classes lends itself to this approach. The feature set of the training set can be comprised of a vector of observed symptoms of the patient. The target object can be a vector that includes a patient's symptoms, along with other features such as their age, ethnicity, sex, and living location.

To assemble the training set for a top-n disease classes classifier, we select features of training example records—existing patients with symptoms that have been diagnosed that is, symptom features that have been mapped to disease classes. For each patient's symptom vector (features), we generate from training examples a set of unique feature-values. For each of the unique feature-values, we generate from the training set an ordered list of disease classes and counts by disease class of the training examples that include the unique symptom feature-values. We generate counts by feature of the unique feature-values; generate a count of the training examples in the training set; and output a configuration data set for the top-n diseases classifier. The generated training set includes the ordered list of disease classes, the counts by disease class of the training examples, the counts by symptom vector (feature) of the unique feature-values and the count of the training examples in the training set.

The goal is to select the top-n disease classes for each patient using the vector of a patient's symptoms (features). This is not to replace the medical professional, but to present a short list of obvious and perhaps obscure alternative diagnoses for consideration for diagnostic screening. To classify a patient's symptoms, we generate a set of unique feature-values from training examples in the training set. We can output the generated set, ordered list and counts to use for predictive medical diagnosis.

In summary, we can evaluate a patient's symptoms against a compendium of diseases to choose the disease with the greatest posterior likelihood given the vector of observed symptoms of the patient.

### Crowd Sourcing Tasks Use Case

Another relatively new application of machine learning is selecting workers to perform tasks, including repetitious tasks and custom services. The examples that follow are directed to repetitious tasks such as categorization, data verification, photo moderation, tagging, transcription and translation, which are case studies for use of Amazon Mechanical Turk. These tasks can be performed in a short elapsed time by crowd sourcing parts of the task to many workers who are working simultaneously, in parallel. Other tasks may require a skilled person with a rare combination of experiences.

An interesting question in the context of crowd sourcing is, “who is available, capable and experienced to do a specific task?” If we assume independence between task features, Naive Bayes classifier (NBC) becomes an interesting technology for implementing a crowd sourcing system for this problem. We can apply naive Bayes classifier (NBC) with active-feature ordering, due to a large set of workers in the thousands and sparse feature vectors that describe tasks performed and to be assigned.

For example, Amazon Mechanical Turk (MTurk) is a crowdsourcing Internet marketplace that enables individuals and businesses (known as requesters) to coordinate the use of human intelligence to perform tasks that computers are currently unable to do. The requesters are able to post tasks, such as choosing the best among several photographs of a storefront, writing product descriptions, or identifying performers on music CDs. Workers can then browse and choose among existing tasks and complete the tasks for a monetary payment set by the requester.

In the MTurk example, the many thousands of workers are the classes. The training set can be assembled from reported counts or from individual tasks performed by the workers or a combination. At the outset, it may be preferred for workers to indicate their aggregate experience at certain tasks, such as refining machine translation of travel-related web sites from Italian to English. Instead of listing a hundred projects involving this type of translation, a worker registering could identify the task by its features and give a count of past tasks performed. As the worker performed additional tasks of this sort within the system, records of performance could automatically accumulate, including ratings of the performances. The user interface for collecting worker information can include a process that maps worker narratives or term vectors into proposed categorical features, such as the number of experiences a worker has with a particular task (feature).

The target objects are new tasks to be assigned. Tasks can be characterized by at least three task features selected from among at least 1,000 feature choices. That is, the target object is a record of the task features of a task that can be assigned to a specific worker. A task has a sparse feature vector.

The system returns n-top choices of workers whose count of task feature experience best indicates capability to perform. Workers in the n-top group can receive a special notification that they have been nominated to perform a task. Or, workers who have indicated availability can be identified to the requestors as good top candidates that the requestors can select to recruit for the task. When evaluating the n-top workers, the task feature experience count of an individual worker can be qualified or weighted by or reported with performance ratings. The classifier identifies workers who have completed the most tasks with the particular features of the target object, optionally taking into account performance ratings. That is, the system identifies workers, who are experienced, to do the target task.

### Computer System

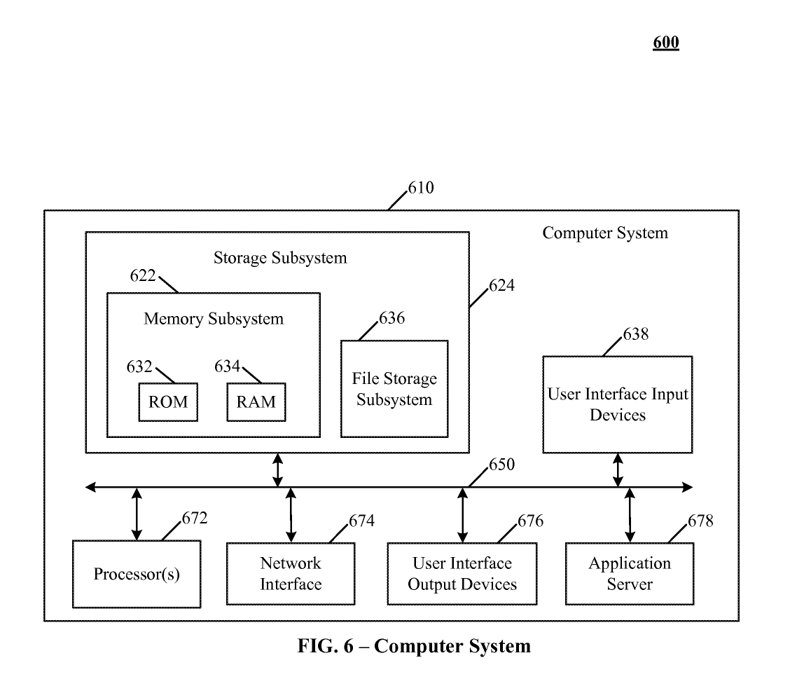

FIG. 6 is a block diagram of an example computer system 600. FIG. 6 is a block diagram of an example computer system, according to one implementation. The processor can be an ASIC or RISC processor. It can be an FPGA or other logic or gate array. It can include graphic processing unit (GPU) resources. Computer system 610 typically includes at least one processor 672 that communicates with a number of peripheral devices via bus subsystem 650. These peripheral devices may include a storage subsystem 624 including, for example, memory devices and a file storage subsystem, user interface input devices 638, user interface output devices 676, and a network interface subsystem 674. The input and output devices allow user interaction with computer system 610. Network interface subsystem 674 provides an interface to outside networks, including an interface to corresponding interface devices in other computer systems.

User interface input devices 638 may include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 610.

User interface output devices 676 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide a non-visual display such as audio output devices. In general, use of the term “output device” is intended to include all possible types of devices and ways to output information from computer system 610 to the user or to another machine or computer system.

Storage subsystem 624 stores programming and data constructs that provide the functionality of some or all of the modules and methods described herein. These software modules are generally executed by processor 672 alone or in combination with other processors.

Memory 622 used in the storage subsystem can include a number of memories including a main random access memory (RAM) 634 for storage of instructions and data during program execution and a read only memory (ROM) 632 in which fixed instructions are stored. A file storage subsystem 636 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 636 in the storage subsystem 624, or in other machines accessible by the processor.

Bus subsystem 650 provides a mechanism for letting the various components and subsystems of computer system 610 communicate with each other as intended. Although bus subsystem 650 is shown schematically as a single bus, alternative implementations of the bus subsystem may use multiple busses.

Computer system 610 can be of varying types including a workstation, server, computing cluster, blade server, server farm, or any other data processing system or computing device. Due to the ever-changing nature of computers and networks, the description of computer system 610 depicted in FIG. 6 is intended as one example. Many other configurations of computer system 610 are possible having more or fewer components than the computer system depicted in FIG. 6.

### Particular Implementations

In one implementation, a system and method of training for classification includes selecting features of training example records, in a training set, to use for top-n classes classification. For each of the features, a method can include generating a set of unique feature-values from training examples in the training set. For each of the unique feature-values, a method can include generating from the training set an ordered list of classes and counts by class of the training examples that include the unique feature-values; and a method can include outputting the generated set, ordered list and counts to use in a top-n classes classifier.

In some implementations, a method of training for classification may be extended to additionally include generating counts by feature of the unique feature-values, outputting the generated set, ordered list and counts to use in a top-n classes classifier.

In some implementations, a method of training for classification may also be extended to include generating a count of the training examples in the training set, and outputting the generated set, ordered list and counts to use in a top-n classes classifier.

In one implementation, a system and method of classifying objects that includes features can include initializing a top-n classes classifier with a configuration data set that includes sets of unique feature-values, ordered lists of classes that include the unique feature-values, and counts of the training examples for that include both the unique feature-values and the classes.

In some implementations, a system and method of classifying objects can include loading or calculating counts by feature of the unique feature-values and a count of training set elements. A method can further include classifying a target object into up to a predetermined number of classes, including using selected features common to the target object and the configuration data set, beginning with a first feature that has more unique feature-values than other features; and for a first feature-value of the first feature of the target object, evaluating at least relative likelihood of the first feature-value belonging to at least the predetermined number of classes selected from the ordered list of classes for the first feature-value.

A method can further include, for additional feature-values of additional features of the target object, a method of generally processing the additional features in order of decreasing number of unique feature-values per feature, updating joint relative likelihoods of the target object belonging to classes selected using at least the relative likelihoods of the first and additional features; and outputting at least the predetermined number of classes for the target object based on the updated relative likelihoods.

By generally in order of decreasing number of unique-feature values we mean to include strict ordering and variations with similar functions or streamlining processing, similar ways of ordering, and similar results of improved performance. One variation from strict ordering that satisfies generally ordering by decreasing number of unique-feature-values is banding of groups of features. For instance, the first band can be the quartile of features, the second band the second quartile, etc. Within bands of features, intra-band ordering may be relatively unimportant to performance. Another variation from strict ordering that also satisfies the general ordering criteria is inserting random or pseudo-random variations in ordering. For instance, last name could be the first feature considered, before proceeding by decreasing number of unique-feature values. Or, three pairs of features that are adjacent in ordering could be reversed, in an effort to design around this disclosure, but this would still be within the general ordering criteria.

In some implementations, the method is enhanced by further including outputting the at least relative likelihoods for the predetermined number of classes for the target object.

In some implementations, the method is enhanced by further including curtailing processing of classes in a particular ordered list of classes for a particular feature-value when a relative likelihood that the particular feature value belongs to a class drops below a predetermined threshold.

In some implementations, the method is enhanced by further including, after processing the additional features, reevaluating at least some of the classes subjected to curtailed processing and updating the relative likelihoods of the curtailed processing classes prior to the outputting.

In some implementations, the method is enhanced when applied to contact records, wherein the target object is a contact record, the classes are contact contributors that can be contacted for further information about the contact record, and the selected features do not uniquely identify persons identified by the contact records.

In some implementations, a system or method of classifying objects can be applied to diagnostic screening, wherein the target object is a patient characteristics and symptoms record, the classes are disease diagnoses, the training cases are disease diagnoses accompanied by patient characteristics and symptom vectors, and the selected features are patient characteristics and observed symptoms, and can include the patient's age or age range, gender, and location.

In some implementations, a system or method of classifying objects can be applied to crowd sourcing of a task to be divided among multiple workers, wherein the classes are workers, the target object is the target task being assigned, the task being assigned is characterized by at least three task features selected from at least 1,000 categorical task features, the training set includes counts of task features of tasks performed by the workers, and the selected features are features of the target task being assigned.

In some implementations, the method is enhanced wherein groups of features are banded by number of feature-values per feature and generally processing the additional features in order of decreasing number of unique feature-values per feature orders the groups without concern for ordering within the groups.

While the technology disclosed is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the innovation and the scope of the following claims.

What is claimed is:

1. A method of classifying objects that include features, including:
initializing a top-n classes classifier using a configuration data set that includes:
sets of unique feature-values,
counts or relative likelihoods of the unique feature-values in the training examples and of the classes in the training examples, and
ordered lists of classes that include the unique feature-values,
the initializing further including loading or calculating counts by feature of the unique feature-values and a count of training set elements; and
classifying a target object into up to a predetermined number of classes, including:
using selected features common to the target object and the configuration data set, beginning with a first feature that has more unique feature-values than other features;
for a first feature-value of the first feature of the target object, evaluating at least the relative likelihood of the first feature-value belonging to at least the predetermined number of classes selected from the ordered list of classes for the first feature-value;
for additional feature-values of additional features of the target object, generally processing the additional features in order of decreasing number of unique feature-values per feature, and updating joint relative likelihoods of the target object belonging to classes selected using at least the relative likelihoods of the first and additional features; and
outputting at least the predetermined number of classes for the target object based on the updated relative likelihoods.

2. The method of claim 1, further including outputting at least the relative likelihoods for the predetermined number of classes for the target object.

3. The method of claim 1, further including curtailing processing of classes in a particular ordered list of classes for a particular feature-value when a relative likelihood that the particular feature value belongs to a class drops below a predetermined threshold.

4. The method of claim 3, further including, after processing the additional features, further evaluating at least some of the classes found in at least one of the features, but excluded from consideration for others of the features by the curtailed processing, and updating the relative likelihoods to take into account the curtailed processing classes prior to the outputting.

5. The method of claim 1, wherein groups of features are banded by number of feature-values per feature and generally processing the additional features in order of decreasing number of unique feature-values per feature orders the banded groups without concern for ordering within bands.

6. The method of claim 1, applied to contact records, wherein the target object is a contact record, the classes are contact contributors that can be contacted for further information about the contact record, and the selected features include features for at least a partial phone number, email address, company identifier.

7. The method of claim 1, applied to diagnostic screening, wherein the target object is a patient characteristics and symptoms record, the classes are disease diagnoses, the training cases are disease diagnoses accompanied by patient characteristics and symptom vectors, and the selected features are patient characteristics and observed symptoms.

8. The method of claim 7, wherein the patient characteristics include the patient's age or age range, gender, and location.

9. The method of claim 1, applied to crowd sourcing of a task to be divided among multiple workers, wherein the classes are workers, the target object is the target task being assigned, the task being assigned is characterized by at least three task features selected from at least 1,000 categorical task features, the training set includes counts of task features of tasks performed by the workers, and the selected features are features of the target task being assigned.

10. A method of assembling a training set for a top-n classes classifier, including:
selecting features of training example records in a training set to use in a top-n classes classifier;
for each of the features, generating from training examples in the training set a set of unique feature-values;
for each of the unique feature-values, generating from the training set an ordered list of classes and counts by class of the training examples that include the unique feature-values;
generating counts by feature of the unique feature-values;
generating a count of the training examples in the training set; and
outputting a configuration data set for the top-n classes classifier, including at least: the generated training set, the ordered list of classes, the counts by class of the training examples, the counts by feature of the unique feature-values and the count of the training examples in the training set.

11. The method of claim 10, applied to diagnostic screening, wherein the target object is a patient characteristics and symptoms record, the classes are disease diagnoses, the training cases are disease diagnoses accompanied by patient characteristics and symptom vectors, and the selected features are patient characteristics and observed symptoms.

12. The method of claim 11, wherein the patient characteristics include the patient's age or age range, gender, and location.

13. The method of claim 10, applied to crowd sourcing of a task to be divided among multiple workers, wherein the classes are workers, the target object is the target task being assigned, the task being assigned is characterized by at least three task features selected from at least 1,000 categorical task features, the training set includes counts of task features of tasks performed by the workers, and the selected features are features of the target task being assigned.

14. A system that classifies objects that include features, the system including:
a processor, memory coupled to the processor, and computer instructions loaded into the memory that, when executed, cause the processor to perform actions comprising:
initializing a top-n classes classifier using a configuration data set that includes:
sets of unique feature-values,
counts of the unique feature-values in the training examples and of the classes in the training examples, and
ordered lists of classes that include the unique feature-values;
the initializing further including loading or calculating counts by feature of the unique feature-values and a count of training set elements;
classifying a target object into up to a predetermined number of classes, including:
using selected features common to the target object and the configuration data set, beginning with a first feature that has more unique feature-values than other features;
for a first feature-value of the first feature of the target object, evaluating at least relative likelihood of the first feature-value belonging to at least the predetermined number of classes selected from the ordered list of classes for the first feature-value;
for additional feature-values of additional features of the target object, generally processing the additional features in order of decreasing number of unique feature-values per feature, and updating joint relative likelihoods of the target object belonging to classes selected using at least the relative likelihoods of the first and additional features;
outputting at least the predetermined number of classes for the target object based on the updated relative likelihoods.

15. The system of claim 14, further including outputting the at least relative likelihoods for the predetermined number of classes for the target object.

16. The system of claim 14, further including curtailing processing of classes in a particular ordered list of classes for a particular feature-value when a relative likelihood that the particular feature value belongs to a class drops below a predetermined threshold.

17. The system of claim 14, further including, after processing the additional features, further evaluating at least some of the classes found in at least one of the features, but excluded from consideration for others of the features by the curtailed processing, and updating the relative likelihoods to take into account the curtailed processing classes prior to the outputting.

18. The system of claim 14, wherein groups of features are banded by number of feature-values per feature and generally processing the additional features in order of decreasing number of unique feature-values per feature orders the banded groups without concern for ordering within bands.

19. A tangible non-transitory computer readable medium loaded with computer instructions that, when executed, cause a processor to perform actions comprising:
initializing a top-n classes classifier using a configuration data set that includes:
sets of unique feature-values,
counts of the unique feature-values in the training examples and of the classes in the training examples, and
ordered lists of classes that include the unique feature-values;
the initializing further including loading or calculating counts by feature of the unique feature-values and a count of training set elements;
classifying a target object into up to a predetermined number of classes, including:
using selected features common to the target object and the configuration data set, beginning with a first feature that has more unique feature-values than other features;
for a first feature-value of the first feature of the target object, evaluating at least relative likelihood of the first feature-value belonging to at least the predetermined number of classes selected from the ordered list of classes for the first feature-value;
for additional feature-values of additional features of the target object, generally processing the additional features in order of decreasing number of unique feature-values per feature, and updating joint relative likelihoods of the target object belonging to classes selected using at least the relative likelihoods of the first and additional features; and
outputting at least the predetermined number of classes for the target object based on the updated relative likelihoods.

20. The tangible non-transitory computer readable medium of claim 19, further including outputting the at least relative likelihoods for the predetermined number of classes for the target object.

21. The tangible non-transitory computer readable medium of claim 19, further including curtailing processing of classes in a particular ordered list of classes for a particular feature-value when a relative likelihood that the particular feature value belongs to a class drops below a predetermined threshold.

22. The tangible non-transitory computer readable medium of claim 21, further including, after processing the additional features, further evaluating at least some of the classes found in at least one of the features, but excluded from consideration for others of the features by the curtailed processing, and updating the relative likelihoods to take into account the curtailed processing classes prior to the outputting.

23. The tangible non-transitory computer readable medium of claim 19, wherein groups of features are banded by number of feature-values per feature and generally processing the additional features in order of decreasing number of unique feature-values per feature orders the banded groups without concern for ordering within bands.

24. The tangible non-transitory computer readable medium of claim 19, further including the code implementing actions that apply the top-n classes classifier to diagnostic screening:
wherein the target object is a patient characteristics and symptoms record, the classes are disease diagnoses, the training cases are disease diagnoses accompanied by patient characteristics and symptom vectors, and the selected features are patient characteristics and observed symptoms.

25. The tangible non-transitory computer readable medium of claim 19, further including the code implementing actions that apply the top-n classes classifier to crow sourcing of a task to be divided among multiple workers:
wherein the classes are workers, the target object is the target task being assigned, the task being assigned is characterized by at least three task features selected from at least 1,000 categorical task features, the training set includes counts of task features of tasks performed by the workers, and the selected features are features of the target task being assigned.
